(19) United States
(12) Patent Application Publication
(10) Pub. No.: US 2015/0306601 A1
(43) Pub. Date: Oct. 29, 2015

(54) MOVEABLE JAW MOUNTING ASSEMBLY

(71) Applicant: SANDVIK INTELLECTUAL PROPERTY AB, Sandviken (SE)

(72) Inventor: Roger NORDBORG, Sandviken (SE)

(21) Appl. No.: 14/443,023

(22) PCT Filed: Nov. 15, 2012
(86) PCT No.: PCT/EP2012/072663

§ 371 Date: May 14, 2015

(51) Int. Cl. B02C 1/02

(52) U.S. Cl. CPC B02C 1/025

(57) ABSTRACT

A tension assembly for a jaw crusher includes a mechanical actuator and bias member. A robust and compact arrangement is provided by positioning the bias member, in the form of a coil spring, over the actuator rod and to configure the force transmission pathway through the linear actuator and into the coil spring so as to follow a reverse pathway through the assembly.

### FIELD OF INVENTION

The present invention relates to a mounting assembly for a moveable jaw of a jaw crusher, and in particular, although not exclusively, to a moveable jaw actuator positioned between a region of the moveable jaw and a jaw support frame.

### BACKGROUND ART

Jaw crusher units typically comprise a fixed jaw and a movable jaw that define a crushing zone therebetween. A drive mechanism is operative to rock the movable jaw back and forth in order to crush material in the crushing zone.

The crushing zone is generally convergent towards its lower discharge end so that crushable material fed to the upper and wider end of the zone is capable of falling downward under gravity whilst being subject to repeated cycles of crushing movement in response to the cyclical motion of the movable jaw. The crushed material is then discharged under gravity through the lower and narrower discharge end onto a conveyor belt for onward processing or discharge from the crusher unit to a suitable stock pile.

Commonly, the frame that supports the fixed jaw is referred to as the front frame end. The moveable jaw is connected to what is typically referred to as a back frame end via a mechanically actuated link mechanism that serves to control and stabilise the oscillating movement of the jaw relative to the stationary jaw. Typically, the link mechanism is both statically and dynamically linearly adjustable to control the grade or size of the resultant crushed material, to facilitate absorption of the impact forces generated by the crushing action and to expand or open the crushing zone to prevent damage to the crusher in the event of non-crushable material being accidentally introduced into the crushing zone.

Example jaw crushers comprising linkage assemblies connecting the back frame and front frame end are described in FR 2683462; EP 0773067; WO 97/36683; U.S. Pat. No. 5,799,888; WO 02/34393; WO 2008/010072 , JP 2009-297591 EP 0148780, JP 60-251941, U.S. Pat. No. 7,143,970 and CN 2832296.

Jaw crushers of the types identified above typically include a retraction or tension assembly mounted at a lower region of the moveable jaw that is operative to set or control the separation distance of the moveable jaw and the fixed jaw. This is useful to selectively adjust the jaw separation distance to either accommodate larger rocks within the crushing zone or allow passage of uncrushable material to exit the crusher and avoid damage. In some cases, a hydraulic actuator is used to mechanically separate the jaws in which a piston rod acts upon a piston that slides within a main cylinder barrel.

Conventionally, the piston rod attaches to a lower region of the moveable jaw with the cylinder barrel mounted at a support frame. In some instances, a coil spring extends longitudinally from the cylinder to provide an additional mounting linkage between the cylinder and the crusher frame. The coil spring is typically operative to absorb the small impact forces resultant from the crushing motion of the moveable jaw whilst the hydraulic cylinder is operative to adjust the jaw separation distance typically referred to as the close side setting (CSS).

However, conventional jaw mounting assemblies are disadvantageous due largely to their construction and the necessary positioning at a lower and rear region of the crusher. In particular, where a conventional assembly includes a linear mechanical actuator coupled to a spring, the combined length of the assembly is often difficult to accommodate within the limited space available at the lower/rear region of the crusher. What is required is a jaw mounting assembly that addresses these problems.

### SUMMARY OF THE INVENTION

It is an object of the present invention to provide a robust and compact moveable jaw mounting assembly operative to set and control the position and motion of the moveable jaw forming part of the jaw crusher. It is a further objective to minimise stress and load bearing concentrations on the various components of the mounting assembly.

The objective is achieved, in part, by providing a mounting assembly comprising a linear mechanical actuator coupled to a bias member, optionally in the form of a coil spring, in which the bias member extends over a region of the linear actuator so as to reduce the overall length of the assembly. Additionally, by configuration of the assembly to mount the moveable jaw via firstly the linear actuator and then secondly the bias member, the force transmission pathway through the assembly is optimised to minimise stress concentrations and provide efficient load transfer to the back frame end part of the jaw crusher frame.

According to a first aspect of the present invention there is provided a moveable jaw mounting assembly for a jaw crusher, the assembly comprising: a mechanical actuator to provide a pulling and/or a pushing force to a moveable jaw of the crusher, the actuator comprising: a barrel having an internal chamber; a piston housed within the chamber and capable of reciprocating linear sliding movement within the chamber; a piston rod attached to the piston and capable of longitudinal reciprocating extension and retraction relative to the barrel, the rod having a first end positioned furthest from the barrel; a bias member to provide a return force to the moveable jaw; a load bearing support frame to couple at least a part of the assembly to a part of the jaw crusher; characterised in that: a region of the barrel is connected to the moveable jaw; the bias member comprises a first and a second end, the bias member coupled to a region of the piston rod substantially at or towards the first end of the bias member; the support frame comprises a mount region to mount the bias member at or towards the second end; and wherein the mount region is positioned between a region of the barrel and the first end of the rod in the longitudinal axis direction such that the bias member extends over at least a region of the rod.

Preferably, the mount region is positioned between the first end of the rod and an end of the barrel from which the rod extends. Preferably, the first end of the bias member is connected to substantially the first end of the rod and the second end of the bias member is mounted to the mount region.

Preferably, the barrel is connected via one end to the moveable jaw.

Preferably, the bias member is a coil spring. Preferably, the spring is coiled to follow helical turns about a central longitudinal axis to create a generally hollow cylindrical body.

Preferably, the actuator is a hydraulic mechanical actuator. Alternative the actuator is a pneumatic mechanical actuator.

Preferably, the rod is mountable at or towards its first end to the jaw crusher via the bias member and the mount region of the support frame. Preferably, the support frame comprises an aperture through which the rod passes.

Preferably, the mount region for the bias member is positioned adjacent the aperture. Optionally, the mount region for the bias member extends substantially perpendicular to a longitudinal axis of the rod.

Preferably, the full length of the bias member is positioned to extend over the rod from or towards the first end of the rod.

According to a second aspect of the present invention there is provided a jaw crusher comprising a mounting assembly as described herein. Preferably, the support frame is rigidly mounted to a back frame end of the crusher.

### BRIEF DESCRIPTION OF DRAWINGS

A specific implementation of the present invention will now be described, by way of example only, and with reference to the accompanying drawings in which:

FIG. 1 is an underside perspective view of a jaw crusher comprising a moveable jaw mounting assembly according to a specific implementation of the present invention;

FIG. 2 is a magnified view of the mounting assembly of FIG. 1 comprising a linear mechanical actuator coupled to a coil spring to provide an intermediate mounting between the back frame end and the moveable jaw of the crusher;

FIG. 3 is a perspective view of the linear actuator and coil spring forming part of the assembly of FIG. 2.

### DETAILED DESCRIPTION OF PREFERRED EMBODIMENT OF THE INVENTION

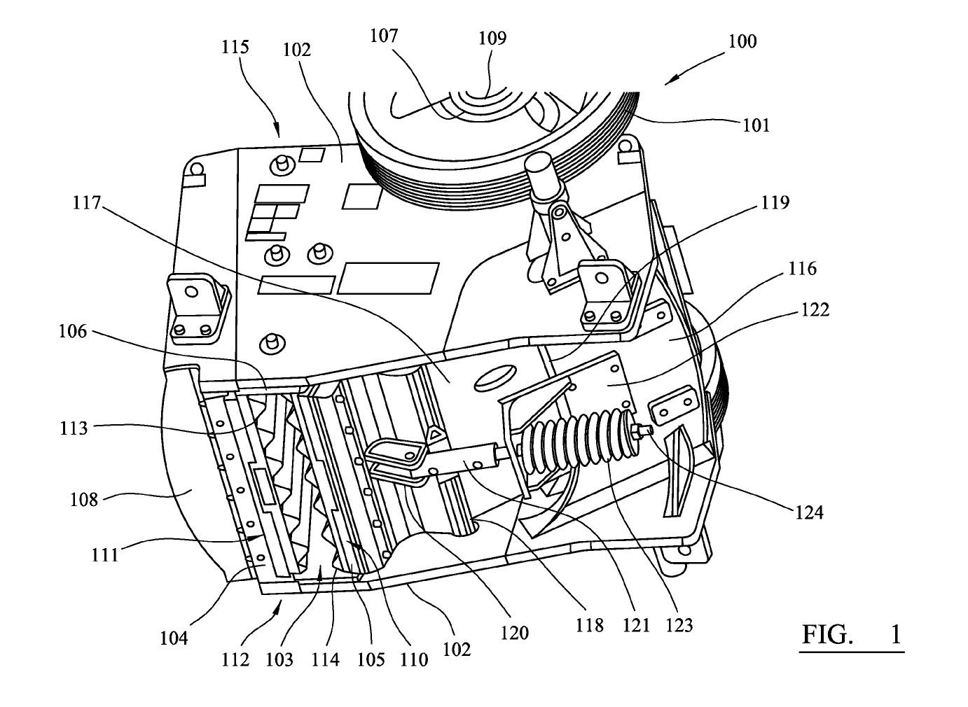

Referring to FIG. 1, a jaw crusher unit 100 comprises a main frame 102 upon which is mounted a moveable jaw 105 and a substantially fixed jaw 104. The movable jaw 105 is mounted eccentrically at a rotatable shaft 107 (extending from underneath an end cap 109) and is positioned separated and opposed to fixed jaw 104. The orientation of fixed jaw 104 and movable jaw 105 relative to one another is convergent along their respective lengths such that a separation distance between a crushing face 111 of fixed jaw 104 and a corresponding crushing face 110 of movable jaw 105 decreases in the downward lengthwise direction. A suitable wear plate 113 is removably attached to crushing face 111 of fixed jaw 104 and a corresponding wear plate 114 is removably attached to crushing face 110 of movable jaw 105. Main frame 102 comprises two opposed frame walls that support the front frame end 108, which is aligned substantially perpendicular to frame walls 102. The side walls extend either side of fixed jaw 104 and movable jaw 105 to collectively define a crushing zone 103.

The opposed fixed and movable jaws 104, 105 are oriented to be inclined relative to one another and are spaced apart further at their respective upper ends than their lower ends.

Accordingly, the crushing zone 103 is convergent from an upper feed region 115 to a lower discharge region 112.

A pair of pulley wheels 101 are mounted either end of shaft 107 at an external facing side of side frame walls 102 being external to the crushing zone 103. Movable jaw 105 is thereby configured for gyroscopic or eccentric motion with respect of fixed jaw 104 as pulley wheels 101 and shaft 107 are rotated via a suitable drive belt (not shown) attached to a drive motor (not shown). This movement of jaw 105 provides the necessary crushing action for material within zone 103 between the opposed wear plates 113 and 114. Material to be crushed is introduced into zone 103 via the open upper region 115 where it is crushed between jaws 104, 105 and subsequently discharged via the open lower region 112. A plurality of removably mounted side liners 106 are attached to each side frame wall 102 at the region of crushing zone 103.

The moveable jaw 105 is supported by a back frame end 116. In particular, back frame end 116 mounts a mechanically actuated linkage that is coupled to a lower region of moveable jaw 105 so as to support and stabilise the oscillating movement of jaw 105. The linkage comprises a collapsible link member, typically referred to as a toggle plate 117 coupled at one side to moveable jaw 105 via seating bush 118. A second side of toggle plate 117 is secured to a second seating bush 119 mounted towards back frame end 116. Toggle plate 117 acts as a collapsible connecting member between the rear support frame 116 and moveable jaw 105 such that jaw 105 is retained in floating manner with respect to main frame 102 and stationary jaw 104 to allow moveable jaw 105 to freely oscillate by reciprocating motion induced by shaft 107.

Crusher 100 further comprises a tension or alternatively termed a retraction assembly attached at a lower region of moveable jaw 105. The assembly includes a linear mechanical actuator in the form of a hydraulic cylinder having a barrel 121 and an elongate rod 124 capable of reciprocating extension and retraction from barrel 121. Barrel 121 is mounted to the moveable jaw 105. The retraction assembly is further mounted at the jaw crusher 100 via a mount frame 122 rigidly attached to a lower region of back frame end 116.

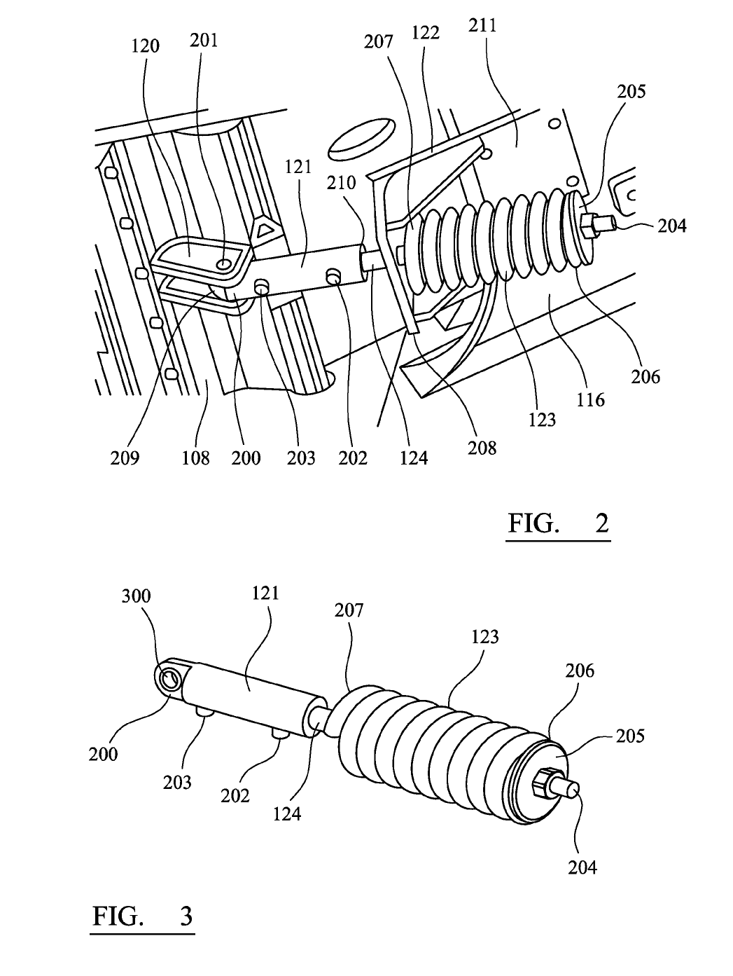

Referring to FIG. 2, barrel 121 comprises a first end 209 having a mounting region 200 for attachment to a flange 120 projecting downwardly from a lower region of moveable jaw 105. A bearing 201 secures barrel mounting 200 at first end 209 to flange 120. Bearing 201 extends through a mounting eyelet 300 provided at mounting region 200. Accordingly, the second open end 210 of barrel 121 is positioned furthest from moveable jaw 105 and extends rearwardly from jaw 105 towards back frame end 116. Elongate rod 124 projects from second end 210 and comprises a length being greater than barrel 121. Rod 124 comprises a first end 204 positioned furthest from barrel 121 and moveable jaw 105. A second end (not shown) is accommodated within barrel 121 and is attached to a piston (not shown) according to a conventional hydraulic cylinder arrangement. The cylinder further comprises two fluid inlet and outlet ports 202, 203 to allow fluid exchange at the internal chamber (not shown) of the cylinder 121. A pump (not shown) is coupled to either or both inlet and outlets 202, 203 to provide hydraulic fluid circulation into and from the internal chamber (not shown). Accordingly, rod 124 is forced to extend and retract from barrel 121 in response to the introduction or extraction of fluid from within the barrel chamber (not shown).

A helically coiled spring 123 comprises a longitudinal axis that is arranged parallel with a longitudinal axis of rod 124. Spring 123 comprises a longitudinal length that is shorter than rod 124 such that the entire length of spring 207 is positioned between rod first end 204 and the second end 207 of barrel 121. Spring 123 comprises a first end 206 positioned at or towards rod first end 204. A second end 207 of spring 123 is positioned in close proximity to second end 210 of barrel 121. Spring 123 is coiled into a generally hollow cylindrical configuration. Additionally, a radius of the coiled cylinder 123 is greater than a radius of rod 124 such that rod 124 extends within the central hollow of the coil 123.

A disk-like mounting body 205 is attached towards rod first end 204 to provide a first coupling region for spring 123. Spring end 206 abuts one side of disk-like body 205. A second end 207 of spring 123 is coupled and positionally retained at support frame 122. In particular, one end of frame 122 comprises a first plate-like body that is secured to the underside of back frame end 116. A second end of frame 122 comprises a second plate-like body 208 that extends transverse to plate 211. The second plate 208 comprises an aperture (not shown) and extends substantially perpendicular to the longitudinal axis of rod 124 and the cylindrical coil of spring 123. Plate 208 is positioned in close proximity to second end 210 of barrel 121 and is separated from end 211 by a relatively short section of rod 124. Rod 124 projects from end 210 through the plate aperture (not shown) such that the majority of the length of rod 124 extends beyond a back frame end side of plate 208 relative to a front frame end side that is received within cylinder 121. Spring second end 207 abuts a face of plate 208 at the region surrounding the aperture (not shown). In this configuration, spring 123 is mounted in position about rod 124 between disk-like body 205 and mounting plate 208 of support frame 122. Each spring end 206, 207 may be positionally retained at each respective mounting region 205, 208 by additional mountings (not shown). Such mountings may include for example welding, eyelets, hooks, loops, sleeves, slotted projections or cabling as will be appreciated by those skilled in the art. Such configurations positionally lock spring ends 206, 207 at their respective mounting bodies 205, 208 such that spring 123 is tethered at both ends 206, 207.

In use, hydraulic fluid is either introduced or extracted from the cylinder chamber (not shown) via port 202, 203. Rod 124 is then forced to extend or retract relative to barrel 121. In an extension stroke, the cylinder must act against the return bias force of spring 123. In the reverse rod retraction stroke, spring 123 assists with the return action as rod 124 retracts into barrel 121. The extension and retraction of rod 124 relative to barrel 121 has the effect of respectively increasing and decreasing the separation distance between moveable jaw 105 and stationary jaw 104.

During a crushing operation, moveable jaw 105 follows an oscillatory cyclical motion induced by rotating shaft 107 and undergoes additional lateral movements due to the impact loading forces resulting from the crushing action against stationary jaw 104. These relatively short-length lateral movements are accordingly transmitted through moveable jaw 105 and into barrel 121 via mount 120 and bearing 201. The force continues through rod 124 in a direction towards back frame 116. The force transmission pathway then reverses direction by passing through disk-like mount 205 and into spring 123 for subsequent transfer into mounting frame 122 and then into back frame end 116. Spring 123 therefore is configured to absorb and transmit the small lateral forces impart by the crushing action of moveable jaw 105.

The present retraction and tension assembly provides a compact and robust arrangement to withstand such loading forces in addition to proving adjustment of the close side setting

(CSS). Due to the positioning of spring 123 over rod 124 and the respective coupling of the spring ends to the rod and the support frame, the total length of the force transmission pathway is significantly reduced with regard to conventional retraction assemblies.

1. A moveable jaw mounting assembly for a jaw crusher, the assembly comprising:
a mechanical actuator to provide a pulling and/or a pushing force to a moveable jaw of the crusher, the actuator comprising a barrel having an internal chamber, a piston housed within the chamber and capable of reciprocating linear sliding movement within the chamber; a piston rod attached to the piston and capable of longitudinal reciprocating extension and retraction relative to the barrel, the rod having a first end positioned furthest from the barrel;
a bias member to provide a return force to the moveable jaw; and
a load bearing support frame to couple at least a part of the assembly to a part of the jaw crusher, wherein a region of the barrel is connected to the moveable jaw, the bias member including a first and a second end, the bias member being coupled to a region of the piston rod substantially at or towards the first end of the bias member, the support frame including a mount region to mount the bias member at or towards the second end, and wherein the mount region is positioned between a region of the barrel and the first end of the rod in the longitudinal axis direction such that the bias member extends over at least a region of the rod.

2. The assembly as claimed in claim 1, wherein the mount region is positioned between the first end of the rod and an end of the barrel from which the rod extends.

3. The assembly as claimed in claim 1, wherein the first end of the bias member is connected to substantially the first end of the rod and the second end of the bias member is mounted to the mount region.

4. The assembly as claimed in claim 1, wherein the barrel is connected via one end to the moveable jaw.

5. The assembly as claimed in claim 1, wherein the bias member is a coil spring.

6. The assembly as claimed in claim 1, wherein the actuator is a hydraulic mechanical actuator.

7. The assembly as claimed in claim 1, wherein the rod is mountable at or towards its first end to the jaw crusher via the bias member and the mount region of the support frame.

8. The assembly as claimed in claim 1, wherein the support frame comprises includes an aperture through which the rod extends.

9. The assembly as claimed in claim 8, wherein the mount region for the bias member is positioned adjacent the aperture.

10. The assembly as claimed in claim 8, wherein the mount region for the bias member extends substantially perpendicular to a longitudinal axis of the rod.

11. The assembly as claimed in claim 1, wherein substantially a full length of the bias member is positioned to extend over the rod from or towards the first end of the rod.

12. A jaw crusher comprising:
a mounting assembly, the mounting assembly including a mechanical actuator to provide a pulling and/or a pushing force to a moveable jaw of the crusher, the actuator including a barrel having an internal chamber, a piston housed within the chamber and capable of reciprocating linear sliding movement within the chamber; a piston rod attached to the piston and capable of longitudinal reciprocating extension and retraction relative to the barrel, the rod having a first end positioned furthest from the barrel; a bias member to provide a return force to the moveable jaw; and a load bearing support frame to couple at least a part of the assembly to a part of the jaw crusher, wherein a region of the barrel is connected to the moveable jaw, the bias member including a first and a second end, the bias member being coupled to a region of the piston rod substantially at or towards the first end of the bias member, the support frame including a mount region to mount the bias member at or towards the second end, and wherein the mount region is positioned between a region of the barrel and the first end of the rod in the longitudinal axis direction such that the bias member extends over at least a region of the rod.

13. A jaw crusher comprising a mounting assembly as claimed in claim 12, wherein the support frame is rigidly mounted to a back frame end of the crusher.
